(19) United States
(12) Patent Application Publication
(10) Pub. No.: US 2020/0194806 A1
(43) Pub. Date: Jun. 18, 2020

(54) POSITIVE ELECTRODE FOR LITHIUM-AIR BATTERY, METHOD OF PREPARING THE SAME, AND LITHIUM-AIR BATTERY INCLUDING THE SAME

(71) Applicants: Hyundai Motor Company, Seoul (KR); Kia Motors Corporation, Seoul (KR)

(72) Inventor: Gwang Seok OH, Seoul (KR)

(21) Appl. No.: 16/431,569

(22) Filed: Jun. 4, 2019

(30) Foreign Application Priority Data
Dec. 18, 2018 (KR) 10-2018-0164006

(51) Int. Cl. H01M 4/96; H01M 12/08; H01M 4/86; H01M 4/88

(52) U.S. Cl. CPC H01M 4/96; H01M 12/08; H01M 4/8626; H01M 2300/0071; H01M 4/8882; H01M 2004/8689; H01M 4/8875

(57) ABSTRACT

A positive electrode for a lithium-air battery includes a porous film, in which a carbon fiber composite, including an insulation coating layer formed on the outer surface of a tube-type carbon structure, is irregularly arranged. Therefore, it is possible to control the shape and size of a discharge product by inducing generation of the discharge product inside the tube-type carbon structure, thereby reducing overvoltage of a battery and improving the lifespan of the battery.

### CROSS-REFERENCE TO RELATED APPLICATION

This application claims under 35 U.S.C. § 119(a) the benefit of priority to Korean Patent Application No. 10-2018-0164006 filed on Dec. 18, 2018, the entire contents of which are incorporated herein by reference.

### BACKGROUND

### (a) Technical Field

The present disclosure relates to a positive electrode for a lithium-air battery.

### (b) Background Art

In lithium-air batteries, a discharge product is generated when oxygen, lithium ions and electrons meet in an air electrode. The higher the amount of discharge, the more the discharge product in the air electrode, i.e. Li₂O₂, is unevenly and freely enlarged in a toroidal form on the surface of a carbon material. However, because the lithium ion conductivity and electron conductivity of Li₂O₂ are very low, Li₂O₂ cannot be effectively decomposed in charging. Further, when overvoltage is excessively applied, thus decomposing Li₂O₂, an electrolyte and surrounding materials may be decomposed, leading to the shortening of the lifespan of the battery.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

One aspect of the present invention provides a positive electrode for a lithium-air battery, which is capable of controlling the shape and size of a discharge product by inducing generation of the discharge product inside a tube-type carbon structure.

Another aspect of the present invention provides a lithium-air battery capable of reducing overvoltage and having an improved lifespan by controlling the shape and size of a discharge product.

Still another aspect of the present invention provides a positive electrode for a lithium-air battery, which includes a porous film, in which a carbon fiber composite, including an insulation coating layer formed on the outer surface of a tube-type carbon structure, is irregularly arranged, and which is capable of controlling the shape and size of a discharge product by inducing generation of the discharge product inside the tube-type carbon structure, thereby reducing overvoltage of a battery and improving the lifespan of the battery, and relates to a method of preparing the positive electrode and a lithium-air battery including the same.

Yet another aspect of the present invention provides a method of preparing a positive electrode for a lithium-air battery, which includes a porous film in which a carbon fiber composite, including a tube-type carbon structure and an insulation coating layer formed on the outer surface of the carbon structure, is irregularly arranged.

Still a further aspect of the present invention provides a positive electrode for a lithium-air battery, the positive electrode including a porous film including a carbon fiber composite irregularly arranged in three dimensions therein, wherein the carbon fiber composite includes a carbon structure having a tube configuration, and an insulation coating layer formed on the outer surface of the carbon structure.

In an embodiment, the carbon structure may include a carbon material carbonized from at least one selected from the group consisting of glucose, sucrose, starch, polyvinylidene fluoride (PVdF) and a combination thereof.

In another embodiment, the carbon structure may have an inner diameter of 1 to 10 μm.

In still another embodiment, the carbon structure may have a thickness equal to or greater than the thickness of the insulation coating layer.

In yet another embodiment, the insulation coating layer may include at least one oxide-based solid electrolyte selected from the group consisting of LiNbO₃, Li₂WO₄, Li₃PO₄ and a combination thereof.

In still yet another embodiment, the carbon fiber composite may include ventilation holes locally formed in the outer surface thereof.

Yet a further aspect of the present invention provides a lithium-air battery including the above-described positive electrode, a negative electrode, a separator disposed between the positive electrode and the negative electrode, and an electrolyte impregnated inside a carbon structure of the positive electrode and in the separator.

Another further aspect of the present invention provides a method of preparing a positive electrode for a lithium-air battery, the method including preparing a polymer fiber by electrospinning a polymer solution, coating the surface of the polymer fiber with an organic substance, preparing a fiber composite by coating the surface of the organic substance, coated on the polymer fiber, with an oxide-based solid electrolyte, removing the polymer fiber from the fiber composite by thermally decomposing the fiber composite, preparing a carbon fiber composite by carbonizing the organic substance of the fiber composite from which the polymer fiber was removed, and preparing a positive electrode including a porous film by irregularly arranging the carbon fiber composite in three dimensions.

In an embodiment, the polymer fiber may be selected from the group consisting of polystyrene, polyaniline (PANi), and a combination thereof, and may have a melting point of 100 to 500° C.

In another embodiment, the organic substance may include at least one selected from the group consisting of glucose, sucrose, starch, polyvinylidene fluoride (PVdF) and a combination thereof.

In still another embodiment, the coating the surface of the polymer fiber with an organic substance may be performed by dipping the polymer fiber into an organic substance coating solution.

In yet another embodiment, the preparing the fiber composite may be performed through deposition when coating the surface of the organic substance with an oxide-based solid electrolyte, and the deposition may be any one of chemical vapor deposition (CVD), physical vapor deposition (PVD), plasma-enhanced chemical vapor deposition (PECVD) and atomic layer deposition (ALD).

In still yet another embodiment, in the removing the polymer fiber from the fiber composite by thermally decomposing the fiber composite, thermal decomposition may be performed for 1 to 60 minutes at a temperature of 350 to 550° C.

In a further embodiment, in the preparing the carbon fiber composite, carbonization may be performed for 30 minutes to 2 hours at a temperature of 800 to 1000° C.

In another further embodiment, the method may further include, between the preparing the carbon fiber composite and the preparing the positive electrode including a porous film, wet etching the carbon fiber composite.

In still another further embodiment, the wet etching may be performed using at least one solution selected from the group consisting of HF, NaF, KF, NaOH, KOH and a combination thereof.

In yet another further embodiment, the wet etching may be performed for 1 to 60 minutes at a temperature of 70 to 80° C.

In still yet another further embodiment, the carbon fiber composite may include ventilation holes locally formed in the outer surface thereof.

In embodiments, a method of preparing a positive electrode for a lithium-air battery, the method comprising: preparing a plurality of polymer fibers by electrospinning a polymer solution; coating surfaces of the polymer fibers with an organic substance; preparing a plurality of composite fibers by further coating surfaces of the organic substance, coated over the polymer fibers, with an oxide-based solid electrolyte; removing the polymer fibers from the composite fibers by thermally decomposing the polymer fibers in the composite fibers to form a plurality of composite tubes; forming a carbon fiber composite tubes by carbonizing the organic substance of the composite tubes; and preparing a positive electrode comprising a porous film by irregularly arranging the carbon fiber composite tubes in three dimensions.

Other aspects and embodiments of the invention are discussed infra.

### BRIEF DESCRIPTION OF THE DRAWINGS

The above and other features of the present invention will now be described in detail with reference to embodiments thereof illustrated in the accompanying drawings which are given hereinbelow by way of illustration only, and thus are not limitative of the present invention, and wherein:

FIG. 1 is a flowchart showing a method of preparing a positive electrode for a lithium-air battery according to embodiments of the present invention;

FIG. 2 is a view schematically showing a process of preparing a carbon fiber composite of the positive electrode for a lithium-air battery according to embodiments of the present invention;

FIG. 3 is a plan view of the carbon fiber composite of the positive electrode for a lithium-air battery according to embodiments of the present invention, in which an electrolyte is impregnated;

FIG. 4 is a cross-sectional view showing a discharge product generated in the carbon fiber composite of the positive electrode for a lithium-air battery according to embodiments of the present invention during discharging;

FIG. 5 is a cross-sectional view showing a discharge product generated in the etched carbon fiber composite of the positive electrode for a lithium-air battery according to embodiments of the present invention during discharging;

FIG. 6 is an SEM picture showing a polymer fiber prepared through electrospinning in Example 1 of the present invention;

FIG. 7 is an SEM picture showing the diameter of the polymer fiber prepared in Example 1 of the present invention;

FIG. 8 is an SEM picture showing the diameter of a polymer fiber prepared in Example 2 of the present invention;

FIG. 9 is an SEM picture showing a carbon fiber composite prepared in Example 2 of the present invention;

FIG. 10 is an SEM picture showing a discharge product generated on the inner wall of a tube-type carbon structure during discharging in the carbon fiber composite prepared in Example 2 of the present invention;

FIG. 11 is an SEM picture showing the inner wall of the tube-type carbon structure, from which the discharge product was removed, during charging in the carbon fiber composite prepared in Example 2 of the present invention; and

FIG. 12 shows charging/discharging graphs of lithium-air batteries manufactured in Examples 1 to 3 of the present invention and Comparative Example 1.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes, will be determined in part by the particular intended application and use environment.

In the figures, reference numbers refer to the same or equivalent parts throughout the several figures of the drawings.

### DETAILED DESCRIPTION

The above aspects, other aspects, features and advantages of the invention are discussed through embodiments with reference to the accompanying drawings. The invention may, however, be embodied in many different forms, and should not be construed as being limited to the embodiments set forth herein. Rather, these embodiments are provided so that this disclosure will be thorough and complete, and will fully convey the concept of the invention to those skilled in the art.

In the drawings, the same or similar elements are denoted by the same reference numerals even though they are depicted in different drawings. In the drawings, the sizes of structures are exaggerated for clarity. It will be understood that, although the terms “first”, “second”, etc. may be used herein to describe various elements, these elements should not be limited by these terms. These terms are only used to distinguish one element from another. For example, a first element could be termed a second element, and, similarly, a second element could be termed a first element, without departing from the scope of the present invention. Singular forms are intended to include plural forms as well, unless the context clearly indicates otherwise.

It will be further understood that the terms “comprises”, “includes”, and/or “has”, when used in this specification, specify the presence of stated features, integers, steps, operations, elements, components, or combinations thereof, but do not preclude the presence or addition of one or more other features, integers, steps, operations, elements, components, or combinations thereof. In addition, it will be understood that when an element such as a layer, film, region, or plate is referred to as being “on” another element, it can be directly on the other element or intervening elements may also be present. It will also be understood that when an element such as a layer, film, region, or plate is referred to as being “under” another element, it can be directly under the other element or intervening elements may also be present.

Unless otherwise indicated, all numbers, values and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values. Further, where a numerical range is disclosed herein, such range is continuous, and includes unless otherwise indicated, every value from the minimum value to and including the maximum value of such range. Still further, where such a range refers to integers, unless otherwise indicated, every integer from the minimum value to and including the maximum value is included.

In the context of this specification, where a range is stated for a parameter, it will be understood that the parameter includes all values within the stated range, inclusive of the stated endpoints of the range. For example, a range of “5 to 10” will be understood to include the values 5, 6, 7, 8, 9, and 10 as well as any sub-range within the stated range, such as to include the sub-range of 6 to 10, 7 to 10, 6 to 9, 7 to 9, etc., and inclusive of any value and range between the integers which is reasonable in the context of the range stated, such as 5.5, 6.5, 7.5, 5.5 to 8.5 and 6.5 to 9, etc. For example, a range of “10% to 30%” will be understood to include the values 10%, 11%, 12%, 13%, and all integers up to and including 30%, as well as any sub-range within the stated range, such as to include the sub-range of 10% to 15%, 12% to 18%, 20% to 30%, etc., and inclusive of any value and range between the integers which is reasonable in the context of the range stated, such as 10.5%, 15.5%, 25.5%, etc.

The size and shape of a discharge product have a great influence on the capacity, power and lifespan of the lithium-air battery. In an implementation of making lithium-air batteries, in order to effectively decompose a discharge product, a metal or metal oxide catalyst is applied or the structure of a carbon material is improved so as to induce decomposition and generation of a discharge product. However, the catalyst decomposes an electrolyte as well as a discharge product, which may accelerate the shortening of the lifespan. Further, while the improvement of the 3D carbon material structure may generate a large amount of discharge product by expanding a specific surface area (electrochemical reaction area), it is difficult to control the size of a discharge product, and thus overvoltage is likely to occur. Furthermore, because it is difficult to decompose a huge discharge product, there is a limitation to the extent to which the power can be increased and the lifespan can be extended.

In one implementation, lithium-air batteries include a hollow-type carbon material as a positive electrode. However, a discharge product is excessively generated on the outer surface of the carbon material having high electronic conductivity. Further, because it is difficult to control the size of a discharge product generated on the outer surface of the carbon material, it is possible that overvoltage excessively occurs.

As described above, the size and shape of a discharge product have a great influence on the capacity, power and lifespan of a lithium-air battery. Particularly, if the size of a discharge product is not controlled, the charging and discharging of a battery is repeated, which causes the occurrence of overvoltage or accelerates the shortening of the lifespan of the battery. At this time, the discharge product is a discharge product that is generated according to the reaction formula [2Li⁺+2e⁻+O₂→Li₂O₂].

In order to avoid or minimize the foregoing situation, by controlling the shape and size of a discharge product that is generated in a positive electrode of a lithium-air battery, embodiments of the present invention provide a positive electrode for a lithium-air battery, which includes a porous film in which a carbon fiber composite 10, including a tube-type carbon structure 12 and an insulation coating layer formed on the outer surface of the carbon structure 12, is irregularly arranged. In the positive electrode for a lithium-air battery according to embodiments of the present invention, the carbon fiber composite 10 including the insulation coating layer formed on the outer surface of the tube-type carbon structure 12 induces a discharge product 16 to be generated in the tube-type carbon structure 12, thereby enabling control of the size and shape of the discharge product 16.

In addition, the positive electrode for a lithium-air battery according to embodiments of the present invention is capable of reducing the thickness of the discharge product 16 by controlling the inner diameter of the carbon structure 12, thereby improving electron conduction and decomposition of the discharge product 16 during charging. Furthermore, the positive electrode for a lithium-air battery according to embodiments of the present invention is capable of controlling the shape and size of the discharge product 16, thereby decreasing the overvoltage of the battery, facilitating the decomposition of the discharge product 16, and consequently lengthening the lifespan of the battery.

Hereinafter, the above-described positive electrode for a lithium-air battery, a method of preparing the same and a lithium-air battery including the same according to embodiments of the present invention will be described in detail with reference to the accompanying drawings.

The present disclosure relates to a positive electrode for a lithium-air battery, a method of preparing the same, and a lithium-air battery including the same. The positive electrode for a lithium-air battery according to embodiments of the present invention includes a porous film including carbon fiber composites or carbon fiber composite tubes 10 irregularly arranged in three dimensions therein, the carbon fiber composite 10 including a tube-type carbon structure 12 and an insulation coating layer formed on the outer surface of the carbon structure 12.

The carbon structure 12 may include a carbon material carbonized from at least one selected from the group consisting of glucose, sucrose, starch, polyvinylidene fluoride (PVdF) and a combination thereof.

The carbon structure 12 may have an inner diameter of 1 to 10 μm. If the inner diameter of the carbon structure 12 is too small, a discharge product is not smoothly generated, and thus an oxygen reduction reaction (ORR) does not occur normally, whereby the capacity of the battery may not be realized normally. Further, if the inner diameter of the carbon structure 12 is too small, the size of the discharge product 16 also becomes small, whereby the power may increase but the battery capacity may decrease. In embodiments, the inner diameter of the carbon structure 12 is equal to greater than 1 μm so that a discharge product is generated normally, and an oxygen reduction reaction (ORR) occurs normally.

On the other hand, if the inner diameter of the carbon structure 12 is too large, the discharge product 16 becomes too large, and thus overvoltage is excessively applied to decompose the discharge product 16, which may shorten the lifespan of the battery. Further, this may also cause a failure in an oxygen evolution reaction (OER). In embodiments, the inner diameter of the carbon structure is equal to or smaller than 10 μm for inhibiting the discharge product 16 from becoming too large.

In one embodiment, the inner diameter of the carbon structure 12 may be set to a range from 3 to 8 μm. In another embodiment, the inner diameter of the carbon structure 12 may be set to a range from 2 to 4 μm. The inner diameter of the carbon structure 12 may be controlled by adjusting the diameter of a polymer fiber 11 that is prepared through an electrospinning method in an early stage. In embodiments, since electron conduction occurs only on the inner wall of the carbon structure 12 during the ORR, the discharge product 16 may grow only on the inner wall of the carbon structure 12.

The thickness of the carbon structure 12 may be equal to or greater than the thickness of the insulation coating layer to avoid decrease of the lithium ion conductivity and further avoid uneven coating of insulation layer. In embodiments, the thickness of the insulation coating layer may be set to a range from 50 to 100 nm.

The insulation coating layer, which is formed on the outer surface of the carbon structure 12, secures insulation against electron conduction of the carbon structure 12, thereby inducing the discharge product 16 to be generated inside the carbon structure 12, rather than on the outer surface of the carbon structure 12. The insulation coating layer may include at least one oxide-based solid electrolyte selected from the group consisting of LiNbO₃, Li₂WO₄, Li₃PO₄ and a combination thereof.

The carbon fiber composite 10 may induce the transfer of lithium and oxygen ions through an electrolyte 15 impregnated or received inside the carbon tube structure 12, and the carbon structure 12 may induce electron conduction. Since the insulation coating layer is formed on the outer surface of the carbon structure 12, the discharge product 16 is hardly generated on the outer surface of the carbon structure 12, but is induced to be generated inside the carbon structure 12.

The carbon fiber composite 10 may include ventilation holes 21, which are locally formed in the outer surface of the carbon fiber composite 10. The electrolyte 15, lithium ions and oxygen ions may be more effectively transferred through the ventilation holes 21 locally formed in the outer surface of the carbon fiber composite 10. The carbon fiber composite 10 may have a fiber rod configuration.

In addition, embodiments of the present invention provide a lithium-air battery, which includes the above-described positive electrode, a negative electrode, a separator disposed between the positive electrode and the negative electrode, and an electrolyte 15 impregnated inside a carbon structure 12 of the positive electrode and in the separator.

FIG. 1 is a flowchart showing a method of preparing a positive electrode for a lithium-air battery according to embodiments of the present invention. Referring to FIG. 1, the method includes a polymer fiber preparation step S1, an organic substance coating step S2, a fiber composite preparation step S3, a thermal decomposition step S4, a carbonization step S5, and a positive electrode preparation step S6.

In greater detail, the method of preparing a positive electrode for a lithium-air battery according to embodiments of the present invention includes a step of preparing a polymer fiber 11 by electrospinning a polymer solution, a step of coating the surface of the polymer fiber 11 with an organic substance, a step of preparing a fiber composite by coating the surface of the organic substance, coated on the polymer fiber 11, with an oxide-based solid electrolyte, a step of removing the polymer fiber 11 from the fiber composite by thermally decomposing the fiber composite, a step of preparing a carbon fiber composite 10 by carbonizing the organic substance of the fiber composite from which the polymer fiber 11 was removed, and a step of preparing a positive electrode including a porous film by irregularly arranging the carbon fiber composite 10 in three dimensions.

The respective steps of the method of preparing a positive electrode for a lithium-air battery according to embodiments of the present invention will now be described in detail.

(1) Polymer Fiber Preparation Step S1

The polymer fiber preparation step S1 may be a step of preparing polymer fibers 11 by electrospinning a polymer solution. The method may further include, before the step S1, a step of preparing a polymer spinning solution by mixing a spinning solvent with a polymer. The spinning solvent may be dimethylformamide. In the step S1, the polymer fiber 11 may be prepared by electrospinning the polymer solution in the solvent. The solvent may include at least one selected from the group consisting of distilled water, phenol, toluene, ethanol, methanol, propanol and a combination thereof. The electrospinning may be performed for 1 to 3 hours at a flow rate of 0.1 to 1.5 mL/hr and a voltage of 16 to 20 kV.

The polymer fiber 11 may be selected from the group consisting of polystyrene, polyaniline (PANi), and a combination thereof, and may have a melting point of 100 to 500° C. If the polymer fiber 11 is thermally treated at a low temperature and the melting point thereof is too low, it cannot serve as a solid-state support for coating of the organic substance at room temperature. If the melting point is too high, the insulation coating layer may also be removed. In embodiments, the melting point of the polymer fibers 11 is equal to or greater than 100° C. to serve as a solid-state support for coating of the organic substance at room temperature, and the melting point is equal to or less than 500° C. to avoid or minimized removal of the insulation coating layer.

In one embodiment, the melting point of the polymer fiber 11 may be 360 to 440° C. The polymer fiber 11 may have a diameter of 1 to 100 μm.

In the step S1, the length and diameter of the polymer fiber 11 may be controlled by adjusting a nozzle used for electrospinning and the time thereof.

(2) Organic Substance Coating Step S2

The organic substance coating step S2 may be a step of coating the surface of the polymer fiber 11 with an organic substance. The organic substance may include at least one selected from the group consisting of glucose, sucrose, starch, polyvinylidene fluoride (PVdF) and a combination thereof. The organic substance has a viscosity of 1 to 2000 mPa·s at 25° C. and has excellent adhesion to the surface of the polymer fiber 11. The step S2 may be a step of coating the surface of the polymer fiber 11 with an organic substance by dipping the polymer fiber 11 into an organic substance coating solution. The organic substance coating solution may be a solution in which the organic substance is mixed in an amount of 4 to 10% by weight with a commonly used solvent.

(3) Fiber Composite Preparation Step S3

The fiber composite preparation step S3 may be a step of preparing a fiber composite by coating the surface of the organic substance, coated on the polymer fiber 11, with an oxide-based solid electrolyte. The step of preparing the fiber composite may be performed through vacuum deposition when coating the surface of the organic substance with an oxide-based solid electrolyte. Specifically, the vacuum deposition may be any one of chemical vapor deposition (CVD), physical vapor deposition (PVD), plasma-enhanced chemical vapor deposition (PECVD) and atomic layer deposition (ALD). However, the present invention is not limited thereto. Any one of various other methods may be used, so long as an oxide-based solid electrolyte is coated on the surface of the organic substance to form an insulation coating layer having a thickness of 50 to 100 nm.

(4) Thermal Decomposition Step S4

The thermal decomposition step S4 may be a step of removing the polymer fiber 11 from the fiber composite by thermally decomposing the fiber composite.

The step of removing the polymer fiber 11 from the fiber composite by thermally decomposing the polymer fiber 11 in the fiber composite, and this step may be performed for 1 to 60 minutes at a temperature of 350 to 550° C. If the thermal decomposition temperature is too low, the polymer fiber 11 may not be normally removed but may be left behind, which may obstruct the generation of the discharge product 16. If the thermal decomposition temperature is too high, not only the polymer fiber 11 but also the organic substance may be removed, whereby the carbon fiber composite 10 may not be formed normally. In embodiments, the thermal decomposition temperature is equal to or greater than 350° C. for removing substantially the entire portion of the polymer fiber 11, and the thermal decomposition temperature is equal to or smaller than 550° C. to avoid or minimize incomplete removal of the organic substance.

(5) Carbonization Step S5

The carbonization step S5 may be a step of preparing the carbon fiber composite 10 by carbonizing the organic substance of the fiber composite from which the polymer fiber 11 was removed.

In the step of preparing the carbon fiber composite 10, the carbonization may be performed for 30 minutes to 2 hours at a temperature of 800 to 1000° C. If the carbonization temperature is too low, the organic substance may not be completely carbonized but may remain as an impurity in the carbon fiber composite 10. If the carbonization temperature is too high, not only the organic substance but also the oxide-based solid electrolyte may be removed. In embodiments, the carbonization temperature is equal to or greater than 800° C. for carbonization of substantially the entire portion of the organic substance, and the carbonization temperature is equal to or smaller than 1000° C. for avoiding or minimizing removal of the oxide-based solid electrolyte.

In one embodiment, the carbonization may be performed at a temperature of 850 to 950° C., in another embodiment, at a temperature of 880 to 920° C.

FIG. 2 is a view schematically showing the process of preparing the carbon fiber composite 10 of the positive electrode for a lithium-air battery according to embodiments of the present invention. In FIG. 2, (a) shows the plane of the polymer fiber 11 prepared through electrospinning, (b) shows the state in which the organic substance is evenly coated on the surface of the polymer fiber 11, (c) shows the state in which the insulation coating layer is formed by coating the oxide-based solid electrolyte on the surface of the organic substance, and (d) shows the carbon fiber composite 10 prepared by selectively removing only the polymer fiber 11 through thermal decomposition at a low temperature and carbonizing the organic substance at a high temperature. Specifically, (d) in FIG. 2 shows the cross-section of the carbon fiber composite 10, which includes the tube-type carbon structure 12 having therein a hollow region and the insulation coating layer 13 formed on the outer surface of the carbon structure 12. FIG. 3 is a plan view of the carbon fiber composite 10 of the positive electrode for a lithium-air battery according to embodiments of the present invention, in which the electrolyte 15 is impregnated. The tube-type carbon structure 12 of the carbon fiber composite 10 is filled with the electrolyte 15.

(6) Positive Electrode Preparation Step S6

The positive electrode preparation step S6 may be a step of preparing a positive electrode including a porous film by irregularly arranging the carbon fiber composite 10 in three dimensions. The positive electrode including a porous film may be prepared by filtering and flattening the carbon fiber composite 10 on a piece of filter paper made of a glass fiber through a vacuum suction method using a rotary pump.

The method may further include, between the step of preparing the carbon fiber composite 10 and the step of preparing the positive electrode including a porous film, a step of wet etching the carbon fiber composite 10. The wet etching may be performed using at least one solution selected from the group consisting of HF, NaF, KF, NaOH, KOH and a combination thereof. The wet etching may be performed for 1 to 60 minutes at a temperature of 70 to 80° C. Both of the temperature and time conditions for the wet etching are within the foregoing ranges to avoid insufficient etching of the surface of the carbon fiber. Through the wet etching, the ventilation holes 21 may be locally formed in the outer surface of the carbon fiber composite 10. The electrolyte 15, lithium ions and oxygen may be smoothly transferred through the ventilation holes 21. In addition, this makes it possible to effectively control the shape and size of the discharge product 16 that is generated on the inner wall of the tube-type carbon structure 12.

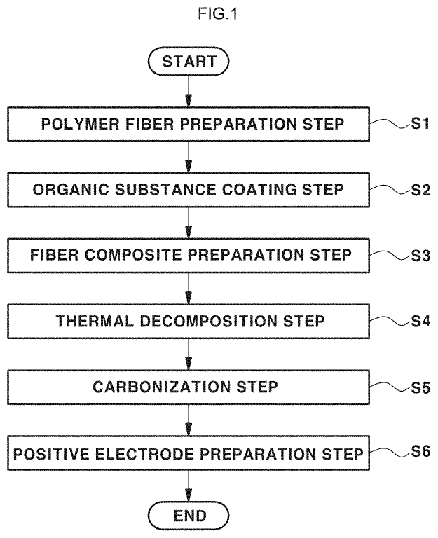

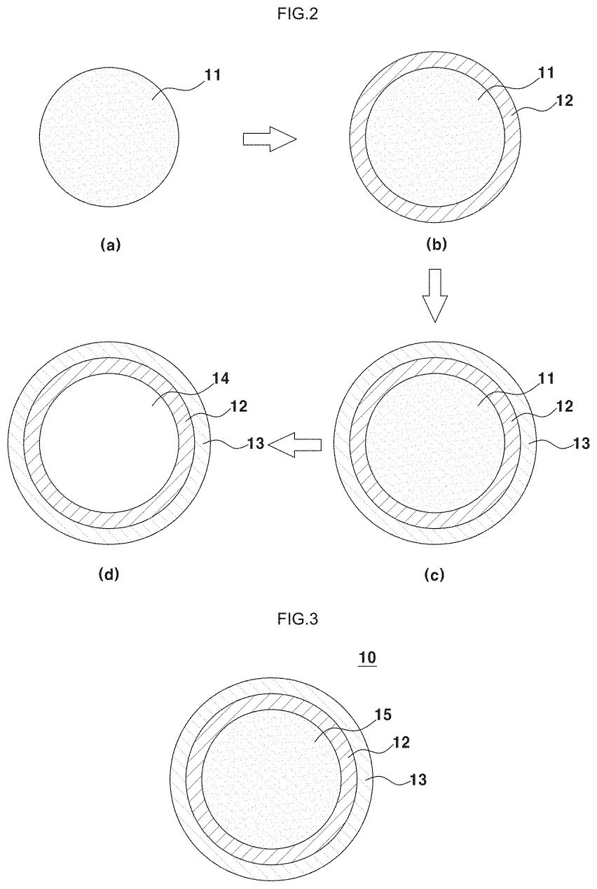

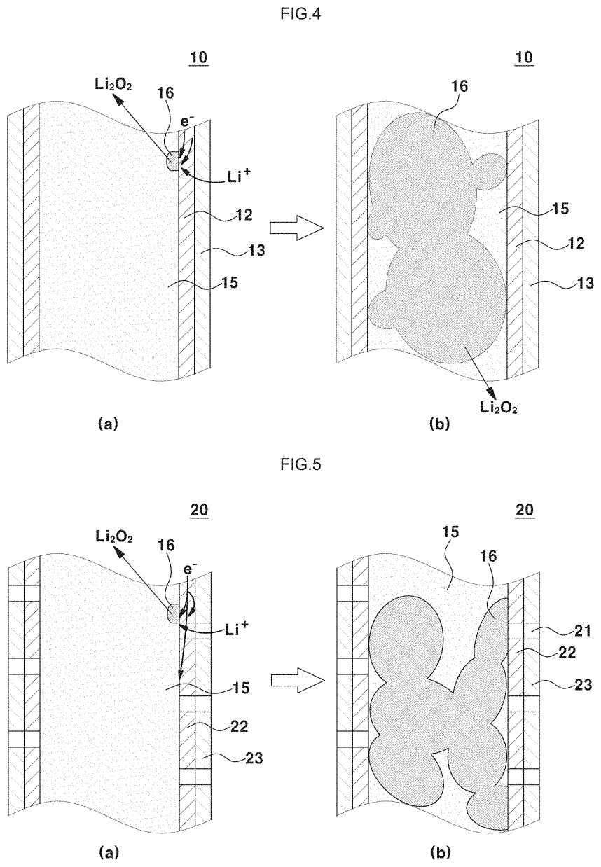

FIG. 4 is a cross-sectional view showing the discharge product 16 generated in the carbon fiber composite 10 of the positive electrode for a lithium-air battery according to embodiments of the present invention during discharging. Referring to FIG. 4, in the positive electrode for a lithium-air battery, the electrolyte 15 is impregnated in the carbon structure 12 of the carbon fiber composite 10, and thus lithium ions and oxygen are transferred. Further, electrons are received by the inner wall of the tube-type carbon structure 12, and thus the discharge product 16 such as Li₂O₂ is generated only on the inner wall of the carbon structure 12. The size of the discharge product 16 is equivalent to the inner diameter of the carbon structure 12, and is very small, e.g., several micrometers. As the size of the discharge product 16 is smaller, the length along which electron conduction is realized is shortened. Thus, the OER may be achieved at a low voltage. In addition, it is possible to lengthen the lifespan of the battery by maintaining a potential range within which the electrolyte 15 is not decomposed.

FIG. 5 is a cross-sectional view showing the discharge product 16 generated in the etched carbon fiber composite 20 of the positive electrode for a lithium-air battery according to embodiments of the present invention during discharging. Referring to FIG. 5, the ventilation holes 21 are locally formed in the outer surface of the carbon fiber composite 20, and thus the transfer of lithium ions and oxygen is more effectively realized. The ventilation holes 21 may be formed so as to penetrate both the carbon structure 22 and the insulation coating layer 23. In addition, the discharge product 16 is evenly dispersed in the carbon fiber composite 20.

Hereinafter, embodiments of the present invention will be described below in more detail with reference to examples set forth herein. However, the present invention is not limited by the following examples.

### Example 1

A polymer solution was prepared in a manner such that polystyrene was mixed in an amount of 25% by weight with dimethylformamide. Subsequently, the polymer solution was electrospun in ethanol for 2 hours with a flow rate of 0.6 mL/hr, a voltage of 18 kV, and a distance of 15 cm from a nozzle to a collector. The diameter of the polystyrene fiber prepared in this manner was 2.7 μm.

An organic substance coating solution was prepared in a manner such that starch was mixed in an amount of 5% by weight with water. The viscosity of the aqueous starch solution was 200 mPa·s at a temperature of 25° C. The polystyrene fibers were dispersed in the organic substance coating solution and were shaken for 2 hours. The surface of the polystyrene fiber was coated with an organic substance by repeating the above process five times.

An oxide-based solid electrolyte coating solution was prepared by adding lithium metal to ethanol and dissolving the same. As a result, lithium ethoxide was manufactured. Subsequently, a coating solution was prepared in a manner such that Nb₂(OC₂H₅)₁₀ was mixed with 3% by weight of lithium ethoxide, based on the amount of polystyrene fiber coated with the organic substance. Subsequently, the polystyrene fiber coated with the organic substance was mixed with the coating solution for 24 hours to coat the surface of the organic substance with LiNbO₃, which was an oxide-based solid electrolyte. As a result, the fiber composite having the insulation coating layer was prepared and was dried at a temperature of 120° C.

Subsequently, the fiber composite was put into an electric furnace and was thermally decomposed for 1 hour at a temperature of 400° C. to remove the polystyrene fiber from the fiber composite. Subsequently, the organic substance in the fiber composite was carbonized for 1 hour at a temperature of 900° C. to be transformed into the carbon structure. As a result, the carbon fiber composite 10 was prepared.

Subsequently, the carbon fiber composite 10 was filtered through a vacuum suction method using a rotary pump. As a result, the positive electrode including a flat porous film was prepared. Subsequently, a coin-cell-type lithium-air battery was manufactured through a commonly used method using the positive electrode prepared in the manner described above. At this time, the diameter of the positive electrode was punched to have a size of 14 mm through electrode punching. For the negative electrode, a lithium metal foil having a thickness of 500 μm was used. For the separator, a polyethylene separator having a thickness of 25 μm was used. The interior of the tube-type carbon structure of the positive electrode and the separator were impregnated with an electrolyte prepared by mixing 1M of LiNO₃ with 100 μl of dimethylacetamide (DMAc).

### Examples 2 and 3

A lithium-air battery was manufactured in the same manner as in Example 1. However, as shown in Table 1 below, the inner diameter of the carbon structure in the carbon fiber composite 10 of the positive electrode was different from that in Example 1.

### Comparative Example 1

A lithium-air battery was manufactured using the polystyrene fiber, prepared in the same manner as in Example 1, as the positive electrode.

### Comparative Example 2

A lithium-air battery was manufactured in the same manner as in Example 1. However, a polystyrene/carbon structure composite fiber was used as the positive electrode.

### Comparative Example 3

A lithium-air battery was manufactured in the same manner as in Example 1. However, a tube-type carbon structure was used as the positive electrode.

### Experimental Example 1: Determination and Evaluation of Generation of Discharge Product in Positive Electrode During Discharging and Charging

In order to determine whether a discharge product was generated in the positive electrode of the lithium-air batteries manufactured in Examples 1 and 2, discharging and charging were performed by applying current to the lithium-air batteries with a pressure of 2 bar and a current density of 0.25 to 3 mA/cm² under an oxygen atmosphere having a purity of 99.999%. The polymer fibers and the carbon fiber composites prepared in Examples 1 and 2 were measured using a scanning electron microscope (SEM). The measurement results are shown in FIGS. 6 to 11.

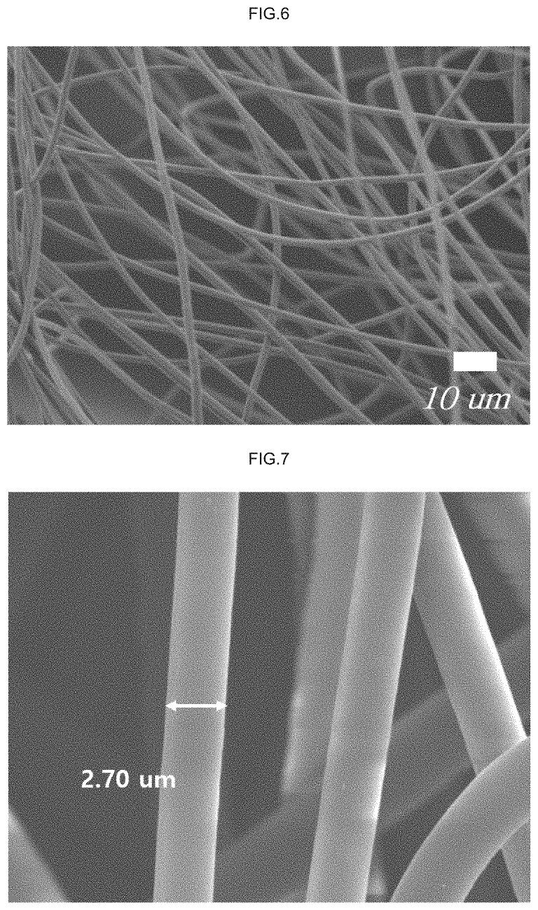

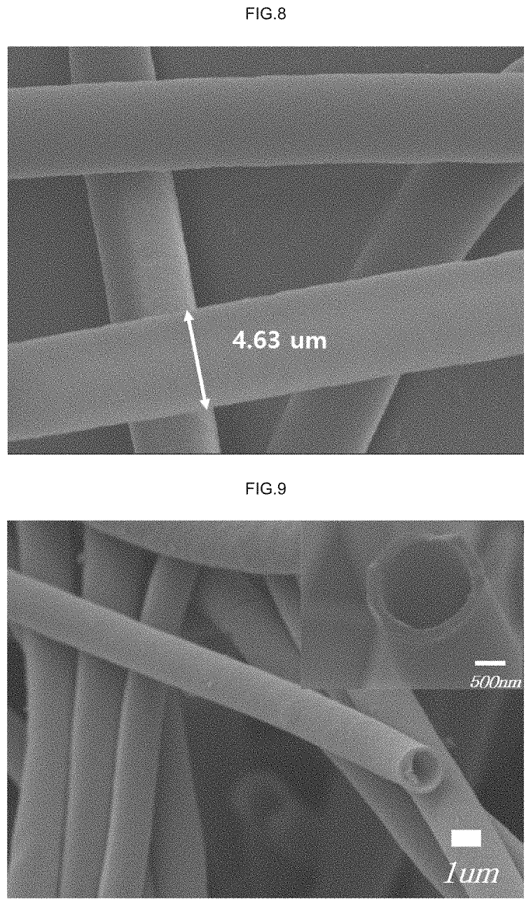

FIGS. 6 and 7 are SEM pictures showing the polymer fiber prepared through electrospinning in Example 1 and the diameter thereof. FIGS. 6 and 7 show that the polymer fiber prepared through electrospinning had a diameter of several micrometers. Accordingly, it is confirmed that the inner diameter of the carbon structure was 2.7 μm.

FIG. 8 is an SEM picture showing the diameter of the polymer fiber prepared in Example 2. It is confirmed from FIG. 8 that the inner diameter of the carbon structure was 4.6 μm. FIG. 9 is an SEM picture showing the carbon fiber composite prepared in Example 2.

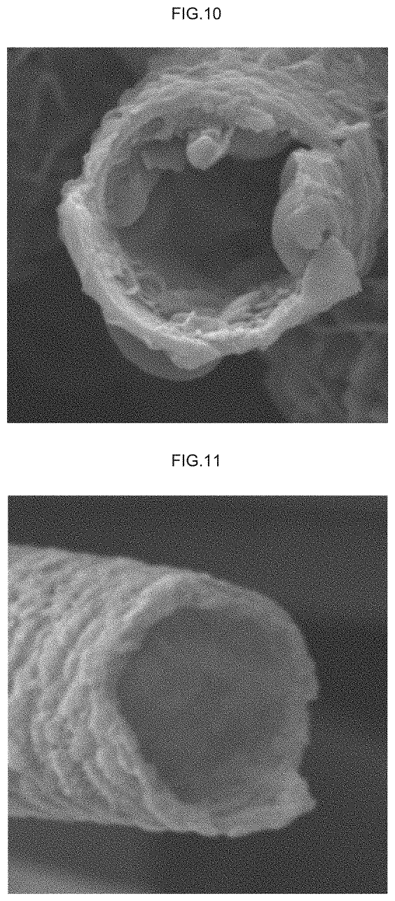

FIG. 10 is an SEM picture showing the discharge product generated on the inner wall of the tube-type carbon structure during discharging in the carbon fiber composite prepared in Example 2. It is confirmed from FIG. 10 that an LNO coating layer was formed on the outer surface of the carbon structure and that the discharge product grew on the inner wall of the tube-type carbon structure.

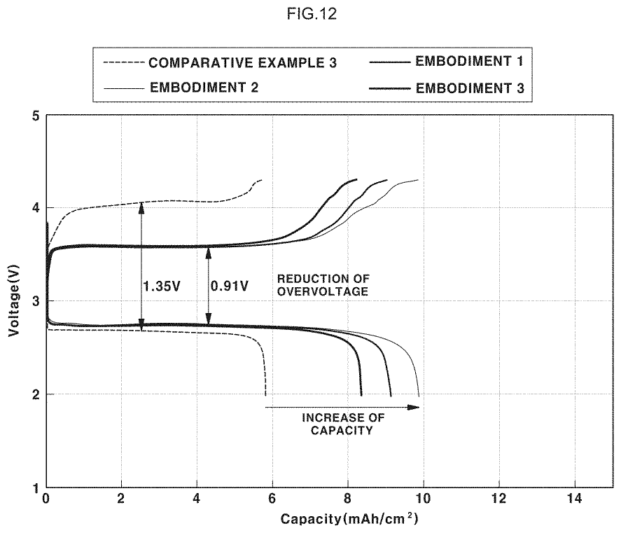

FIG. 11 is an SEM picture showing the inner wall of the tube-type carbon structure, from which the discharge product was removed, during charging in the carbon fiber composite prepared in Example 2. It is confirmed from FIG. 11 that the discharge product generated on the inner wall of the tube-type carbon structure (see FIG. 10) has been completely decomposed during charging.

### Experimental Example 2: Evaluation of Overvoltage, Capacity and Lifespan of Battery

In order to evaluate the overvoltage, capacity and lifespan of the lithium-air batteries manufactured in Examples 1 to 3 and Comparative Examples 1 to 3, discharging and charging were performed by applying current to the lithium-air batteries with a pressure of 2 bar and a current density of 0.25 to 3 mA/cm² under an oxygen atmosphere having a purity of 99.999%. The evaluation results are shown in Table 1 below and in FIG. 12. FIG. 12 shows charging/discharging graphs of the lithium-air batteries manufactured in Examples 1 to 3 and Comparative Example 1.

TABLE 1

| | | | | Overvoltage | |
|---|---|---|---|---|---|
| | | | | (ΔV) | |
| | | | | (Charging | |
| | | Inner | | Potential − | Battery |
| | Core/Shell | Diameter | Capacity | Discharging | Lifespan |
| Classification | Structure | (μm) | (mAh/cm²) | Potential) | (cycles) |
| Comparative | Polystyrene Fiber | 2.7 | — | — | — |
| Example 1 | | | | | |
| Comparative | Polystyrene/Carbon | 2.7 | 3 | 1.34 | 3 |
| Example 2 | Structure Fiber | | | | |
| Comparative | Tube-type Carbon | 2.7 | 5.8 | 1.35 | 15 |
| Example 3 | Structure | | | | |
| Example 1 | Carbon Structure/ | 2.7 | 9.1 | 0.91 | 40 |
| | LNO Coating Layer | | | | |
| Example 2 | Carbon Structure/ | 4.6 | 9.8 | 0.93 | 62 |
| | LNO Coating Layer | | | | |
| Example 3 | Carbon Structure/ | 6.4 | 8.3 | 0.95 | 52 |
| | LNO Coating Layer | | | | |

According to the results shown in Table 1 above and in FIG. 12, in the case of Comparative Example 1, in which the polystyrene fiber prepared through electrospinning was used as the positive electrode, electron conduction was never realized, and thus capacity measurement was impossible. Further, no discharge product was generated.

In the case of Comparative Example 2, because the carbon structure was formed on the surface of the polystyrene fiber, an ORR occurred only on the outer surface of the carbon structure, and thus overvoltage excessively occurred. Further, it is confirmed that the capacity and lifespan of the battery had the lowest values.

In the case of Comparative Example 3, the hollow-tube-type carbon structure was used as the positive electrode. However, an ORR occurred both on the outer surface of the carbon structure and on the inner wall thereof. Particularly, it was impossible to control the size of the discharge product growing on the outer surface of the carbon structure, and thus the discharge product grew irregularly or unevenly big. Thereby, overvoltage occurred. Further, it is confirmed that the capacity and lifespan of the battery had lower values than those in Examples 1 to 3.

On the other hand, in the case of Examples 1 to 3, it is confirmed that it was possible to control the size of the discharge product by adjusting the inner diameter of the tube-type carbon structure in the carbon fiber composite of the positive electrode. In addition, it is confirmed that the discharge product having a thin and uniform size reduced overvoltage and facilitated an OER, and thus reversible lifespan characteristics were improved.

In addition, it is confirmed that, since the LNO coating layer was formed on the outer surface of the carbon structure, electron conduction did not occur and the discharge product grew by inducing an ORR only on the inner wall of the tube-type carbon structure.

In addition, it is confirmed from FIG. 12 that overvoltage was reduced and the capacity and lifespan of the battery increased compared to Comparative Example 3.

In embodiments, a positive electrode for a lithium-air battery comprises: a porous film comprising a plurality of carbon fiber composite tubes 10 or 20 irregularly arranged in three dimensions therein, wherein each of the carbon fiber composite tubes 10 or 20 comprises a carbon tubular wall 12 or 22, an insulation coating layer 13 or 23 formed over an outer surface of the carbon tubular wall 12 or 22 and a plurality of holes 21 formed through the tubular wall.

In embodiments, a method of preparing a positive electrode for a lithium-air battery, the method comprises: preparing a plurality of polymer fibers 11 by electrospinning a polymer solution; coating surfaces of the polymer fibers with an organic substance; preparing a plurality of composite fibers by further coating surfaces of the organic substance, coated over the polymer fibers, with an oxide-based solid electrolyte; removing the polymer fibers from the composite fibers by thermally decomposing the polymer fibers in the composite fibers to form a plurality of composite tubes; forming a carbon fiber composite tubes by carbonizing the organic substance of the composite tubes; and preparing a positive electrode comprising a porous film by irregularly arranging the carbon fiber composite tubes in three dimensions.

As is apparent from the above description, embodiments of the present invention provide a positive electrode for a lithium-air battery, which includes a porous film, in which a carbon fiber composite, including an insulation coating layer formed on the outer surface of a tube-type carbon structure, is irregularly arranged, and which is capable of controlling the shape and size of a discharge product by inducing generation of the discharge product inside the tube-type carbon structure.

Specifically, since the insulation coating layer is formed on the outer surface of the tube-type carbon structure in the carbon fiber composite of the positive electrode for a lithium-air battery, a discharge product is induced to be generated inside the tube-type carbon structure, thereby enabling control of the size and shape of the discharge product.

In addition, it is possible to make the thickness of a discharge product thin by controlling the inner diameter of the carbon structure, thereby improving electron conduction and decomposition of the discharge product during charging.

In addition, it is possible to reduce overvoltage of a battery and improve decomposition of a discharge product by controlling the shape and size of the discharge product, thereby lengthening the lifespan of the battery.

It will be appreciated by those skilled in the art that the effects achievable through the invention are not limited to those that have been particularly described hereinabove, and other effects of the invention will be more clearly understood from the above detailed description.

Embodiments of the invention have been described in detail with reference to embodiments thereof. However, it will be appreciated by those skilled in the art that changes may be made in these embodiments without departing from the principles and spirit of the invention, the scope of which is defined in the appended claims and their equivalents.

What is claimed is:

1. A positive electrode for a lithium-air battery, the positive electrode comprising:
a porous film comprising a carbon fiber composite irregularly arranged in three dimensions therein,
wherein the carbon fiber composite comprises:
a carbon structure having a tube configuration; and
an insulation coating layer formed over an outer surface of the carbon structure.

2. The positive electrode of claim 1, wherein the carbon structure comprises a carbon material carbonized from at least one selected from the group consisting of glucose, sucrose, starch, polyvinylidene fluoride (PVdF) and a combination thereof.

3. The positive electrode of claim 1, wherein the carbon structure has an inner diameter of 1 to 10 μm.

4. The positive electrode of claim 1, wherein the carbon structure has a thickness equal to or greater than a thickness of the insulation coating layer.

5. The positive electrode of claim 1, wherein the insulation coating layer comprises at least one oxide-based solid electrolyte selected from the group consisting of LiNbO₃, Li₂WO₄, Li₃PO₄ and a combination thereof.

6. The positive electrode of claim 1, wherein the carbon fiber composite comprises a tubular wall comprising ventilation holes.

7. A lithium-air battery comprising:
the positive electrode of claim 1;
a negative electrode;
a separator disposed between the positive electrode and the negative electrode; and
an electrolyte impregnated inside a carbon structure of the positive electrode and in the separator.

8. A method of preparing a positive electrode for a lithium-air battery, the method comprising:
preparing a polymer fiber by electrospinning a polymer solution;
coating a surface of the polymer fiber with an organic substance;
preparing a fiber composite by coating a surface of the organic substance, coated over the polymer fiber, with an oxide-based solid electrolyte;
removing the polymer fiber from the fiber composite by thermally decomposing the fiber composite;
preparing a carbon fiber composite by carbonizing the organic substance of the fiber composite from which the polymer fiber was removed; and
preparing a positive electrode comprising a porous film by irregularly arranging the carbon fiber composite in three dimensions.

9. The method of claim 8, wherein the polymer fiber is selected from the group consisting of polystyrene, polyaniline (PANi), and a combination thereof, and has a melting point of 100 to 500° C.

10. The method of claim 8, wherein the organic substance comprises at least one selected from the group consisting of glucose, sucrose, starch, polyvinylidene fluoride (PVdF) and a combination thereof.

11. The method of claim 8, wherein the coating of the surface of the polymer fiber with an organic substance is performed by dipping the polymer fiber into an organic substance coating solution.

12. The method of claim 8, wherein the preparing of the fiber composite is performed through deposition when coating the surface of the organic substance with an oxide-based solid electrolyte, the deposition being any one of chemical vapor deposition (CVD), physical vapor deposition (PVD), plasma-enhanced chemical vapor deposition (PECVD) and atomic layer deposition (ALD).

13. The method of claim 8, wherein, in the removing of the polymer fiber from the fiber composite by thermally decomposing the fiber composite, thermal decomposition is performed for 1 to 60 minutes at a temperature of 350 to 550° C.

14. The method of claim 8, wherein, in the preparing of the carbon fiber composite, carbonization is performed for 30 minutes to 2 hours at a temperature of 800 to 1000° C.

15. The method of claim 8, further comprising: between the preparing of the carbon fiber composite and the preparing of the positive electrode comprising a porous film,
wet etching the carbon fiber composite.

16. The method of claim 15, wherein the wet etching is performed using at least one solution selected from the group consisting of HF, NaF, KF, NaOH, KOH and a combination thereof.

17. The method of claim 15, wherein the wet etching is performed for 1 to 60 minutes at a temperature of 70 to 80° C.

18. The method of claim 15, wherein the carbon fiber composite comprises a tubular wall with ventilation holes.
